(19) United States
(12) Patent Application Publication
(10) Pub. No.: US 2001/0036546 A1
(43) Pub. Date: Nov. 1, 2001

(54) Dimensionally stabilized diffuse reflective articles

(76) Inventors: Scott R. Kaytor, Minneapolis, MN (US); Warren P. Caswell, Cottage Grove, MN (US); Wade D. Kretman, Afton, MN (US)

Correspondence Address: MERCHANT & GOULD PC, P.O. BOX 2903, MINNEAPOLIS, MN, 55402-0903, US

(21) Appl. No.: 09/759,929

(22) Filed: Jan. 12, 2001

Related U.S. Application Data
(63) Continuation-in-part of application No. 09/570,475, filed on May 12, 2000.
Application No. 09/570,475 is a continuation-in-part of application No. 09/368,302, filed on Aug. 3, 1999.

(51) Int. Cl. B32B 3/26

(52) U.S. Cl. 428/316.6; 428/308.4; 428/319.3; 428/321.1

(57) ABSTRACT

Diffuse reflective articles having a first layer formed by thermally induced phase separation of a thermoplastic polymer and a diluent, plus a second layer containing a dimensionally stabilizing polymer are described. Such materials find a wide variety of applications, including in combinations with various light management films. The diffuse reflective articles are useful in applications where high reflectivity is desired, such as backlight units of liquid crystal displays, lights, copy machines, projection system displays, facsimile apparatus, electronic blackboards, diffuse white standards, and photographic lights.

### CROSS-REFERENCE TO RELATED APPLICATIONS

This application is a continuation-in-part of Application Ser. No. 09/570,475, incorporated herein by reference in its entirety.

### TECHNICAL FIELD

The present invention relates to improved reflective articles, including improved diffuse reflective articles formed from a thermoplastic polymer and a diluent using thermally induced phase separation technology (TIPS). In particular, the invention is directed to reflective TIPS articles having one or more layers contributing improved stiffness and dimensional stability to the reflective article.

### BACKGROUND

Diffuse reflective articles provide reflective light luminance at many angles, and a need exists for diffuse reflectors for use in displays, such as liquid crystal display (LCD) computer monitors and televisions. Reflectors serve an important role in many displays because they significantly impact distribution of light and also can significantly impact how much light is lost to absorption within the display. These displays should have uniform, brightly illuminated screens that are highly energy efficient. Uniformity is important because it provides a precise, high quality image. Brightness is important in order to view the display in a variety of ambient light conditions. Energy efficiency is particularly important to remote battery operated devices, such as handheld computers, notebook computers, mobile telephones, etc. where battery life can be improved by having bright, energy efficient displays. Thus, a need exists for diffuse reflective articles that enhance energy efficiency, uniformity, or brightness of illuminated articles.

Common diffuse reflectors are made of white inorganic compounds (such as barium sulfate or magnesium oxide) in the form of pressed cake or ceramic tile, all of which are expensive, stiff, and brittle. Other existing diffuse reflectors include microporous films. One useful technology for producing microporous films is thermally induced phase separation (TIPS) technology. TIPS technology has been used in the preparation of microporous materials by liquid-liquid phase separation of thermoplastic polymers and a diluent as described in U.S. Pat. Nos. 4,247,498 and 4,867,881. A solid-liquid phase separation process is described in U.S. Pat. No. 4,539,256. The use of nucleating agents incorporated in the TIPS microporous material is also described as an improvement in the solid-liquid phase separation method in U.S. Pat. No. 4,726,989.

Although existing TIPS microporous films are useful, a need remains for effective and inexpensive diffuse reflective articles for many of the diverse light management applications that are being developed. Such applications require that the diffuse reflective articles be as thin as possible, particularly when they are used in electronic displays incorporated into notebook computers, handheld computers, portable phones, and other electronic devices. An additional useful attribute for diffuse reflective articles is controlled or reduced shrinking of the reflective articles over time and upon exposure to heat. Many polymeric materials, including those used in various TIPS microporous films, undergo noticeable distortion over time. Reduction or elimination of this distortion is desired in order to produce an optimal diffuse reflective article. Finally, a need exists for thin diffuse reflective articles that have sufficient dimensional stability to maintain their shape while in use. In particular, a need exists for thin diffuse reflective articles that maintain a planer configuration when used in electronic displays, including over the entire temperature range that such electronic displays are likely to experience.

### SUMMARY OF THE INVENTION

The present invention provides diffuse reflective articles incorporating microporous layers using TIPS technology. The diffuse reflective articles exhibit sufficient dimensional stability to provide improved uniformity of reflected light when used in various light management applications, such as reflectors in electronic displays.

In a first implementation, the invention includes reflective articles having at least two layers: a porous diffuse reflective layer and a dimensionally stabilizing polymeric layer. The diffuse reflective layer contains a network formed of a polymeric component and a diluent component. The diluent component is miscible with the polymeric component at a temperature above the melting point of the polymer component, permitting formation of the network under phase separation conditions.

The dimensionally stabilizing polymeric layer provides increased rigidity to diffuse reflective articles, thereby permitting the diffuse reflective articles to be maintained in desired orientations and configurations with less support than necessary with similar films that do not have a dimensionally stabilizing layer. For example, the dimensionally stabilizing polymeric layer allows diffuse reflective articles to be maintained in a substantially planer position when used in liquid crystal displays. This substantially planer orientation can be particularly important in such displays because it aids in producing a more uniform display of reflected light while controlling the weight and thickness of both the diffuse reflector and the liquid crystal display. In particular, in certain embodiments, the present invention permits a diffuse reflective article to be incorporated into a display with reduced support along its back surface, thereby permitting the manufacture of thinner, lighter displays.

The combined thickness of the layers of the reflective article are typically less than 2500 microns, more typically less than 500 microns, and even more typically approximately 250 microns or less. In many applications the total thickness is minimized in order to provide the thinnest possible reflector while maintaining reflective performance characteristics.

The diffuse reflective layer is normally significantly thicker than the dimensionally stabilizing polymeric layer. Therefore, the present invention permits significant improvements in dimensional stability while adding only minimally to the thickness of the reflective article. In specific implementations the diffuse reflective layer is up to 40 times greater than the thickness of the dimensionally stabilizing layer, while in other implementations it is greater than 10 times the thickness of dimensionally stabilizing polymeric layer, while in yet other implementations the diffuse reflective layer is greater than 5 times the thickness of the stabilizing polymeric layer. Thus, for example, in specific implementations the diffuse reflective layer is approximately 225 microns thick, while the dimensionally stabilizing layer is less than 25 microns thick.

The dimensionally stabilizing polymeric layer has a glass transition temperature that is high enough to avoid deformation of the diffuse reflective article at temperatures that can be expected in electronic display and lighting applications. In particular, the glass transition temperature of the dimensionally stabilizing polymeric layer is typically greater than 40° C., more typically greater than 60° C., and even more typically from 90 to 110° C. The glass transition temperature of the material forming the dimensionally stabilizing polymeric layer can be selected based upon the actual conditions under which the reflective article will be used. Suitable polymers for use in this layer include polyethylene terepthalate, polycarbonate, poly(methyl methacrylate), and various acrylic homopolymers and copolymers. In certain embodiments, polypropylene is used as a dimensionally stabilizing layer to reduce curling of the TIPS film, particularly in implementations where less rigidity of the reflective article is acceptable.

The stabilizing layer can also include a high loading of filler, such as a white pigment, which aids in increasing rigidity and increasing the total reflectivity of the multi-layer article. These fillers can include titanium dioxide, zinc oxide, barium sulfate, silica and talc. Conversely, absorbing pigments or dyes such as carbon black can be added to this stabilizing layer to provide near complete opacity.

The dimensionally stabilizing layer of the reflective article can itself be reflective, and such reflectivity can be enhanced by adding a pigment to the stabilizing layer, such as titanium dioxide. The stabilizing layer does not normally contain voids, but some voids can be present in specific embodiments. Also, additional layers besides the two layers described here may be incorporated into the reflective article. These additional layers can include, for example and without limitation, additional reflective or stabilizing layers, absorptive coatings, reflective coatings, protective layers, etc.

The diffuse reflective article provides excellent reflectivity while maintaining a thin cross-section and uniform reflectivity. The present invention further provides an improved diffuse reflector having a reduced thickness while maintaining a high absolute reflectance value. This reduced thickness allows for creation of various products having a narrow profile, including liquid crystal display (LCD) illumination systems.

In specific implementations, the diffuse reflector also has improved dimensional stability relative to prior TIPS articles. This improved dimensional stability allows for the diffuse reflector to be incorporated into products in a manner not possible with existing TIPS reflectors. For example, the diffuse reflector is more self supporting (as measured by its hand value) such that it can be used in applications where only portions of a reflective article are supported from behind.

The diffuse reflective article of the invention can be used along with other light management films to provide improved optical properties for displays, including light valve displays such as LCD devices incorporated into computer monitors, handheld computers, mobile communication devices, etc. The light management films used in association with the diffuse reflector include polarizing films, turning films, brightness enhancing films, diffusers, and films including hemispheres, cylindrical structures or lenslets. The diffuse reflective article can also be combined with a reflective polarizer, retardation film, or other materials for control of light. Collectively, such materials are referred to herein as light management films.

The invention also includes a reflective article comprising a reflective material proximate to a structure. Examples of these structures include, but are not limited to, light guides or hollow light cavities. The reflective article optionally includes a surface having surface elements configured to reduce or eliminate optical coupling with the structure. Examples of these surface elements include, for example, variable height grooves, pyramids, hemispheres, and coated particles. The reflective article can be subject to a mechanical force, such as calendaring, to reduce its thickness. The reflective article preferably has a reflectivity of greater than 92%, more preferably greater than 95%, and even more preferably greater than 98% at a wavelength of 550 nanometers measured using a spectrophotometer with an integrating sphere.

The present invention is also directed to a method of improving diffuse reflectivity of light using a diffuse reflective material to cause light energy to reflect off of it, wherein the material includes a porous polymeric sheet and a dimensionally stabilizing polymeric layer. The porous polymeric sheet has an air region and a material region where the material region forms a network of material containing a polymer component and a diluent component, said diluent component being miscible with the polymer component at a temperature above the melting point of the polymer component or a liquid-liquid phase separation temperature of a total solution.

The invention further includes methods of making reflective articles. The methods include making TIPS reflective articles containing a dimensionally stabilizing layer. A specific method of the invention includes making an article comprising a diffuse reflective material configured for attachment to a structure. The method includes providing a polymer component and a diluent component. The diluent component is miscible with the polymer component at a temperature above the melting point of the polymer component or liquid-liquid phase separation temperature of the total solution of polymer and diluent. The polymer and diluent components are combined to form a porous polymeric sheet, to which is added a polymeric dimensionally stabilizing layer. The dimensionally stabilizing layer provides improved rigidity and stability to the porous polymeric sheet.

Other features and advantages of the invention will be apparent from the following detailed description of the invention and the claims. The above summary of principles of the disclosure is not intended to describe each illustrated embodiment or every implementation of the present disclosure. The drawings and the detailed description that follow more particularly exemplify certain embodiments utilizing the principles disclosed herein.

### BRIEF DESCRIPTION OF THE DRAWINGS

FIG. 1 is cross-sectional schematic diagram of a diffuse reflective film constructed and arranged in accordance with the invention, showing a dimensionally stabilizing layer applied to the exterior of the diffuse reflective film.

FIG. 2 is a cross-sectional schematic diagram of a diffuse reflective film constructed and arranged in accordance with the invention, showing a dimensionally stabilizing layer laminated to the diffuse reflective film.

FIG. 3 is cross-sectional schematic diagram of a diffuse reflective film constructed and arranged in accordance with the invention, showing a dimensionally stabilizing layer positioned in the interior of the diffuse reflective film.

FIG. 4 is a schematic diagram of a liquid crystal display (LCD) device using a diffuse reflective film of the invention.

FIG. 5 is a schematic diagram of a liquid crystal display (LCD) device using a diffuse reflective film of the invention.

While principles of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

The present invention is directed to diffuse reflective articles having a porous polymeric layer and a dimensionally stabilizing polymeric layer. The porous polymeric layer provides high reflectivity of light, while the dimensionally stabilizing polymeric layer provides improved stiffness to the diffuse reflective article. Specifically, the dimensionally stabilizing polymeric layer preserves the reflective article's thin profile without excessively diminishing reflectivity or increasing the weight of the article.

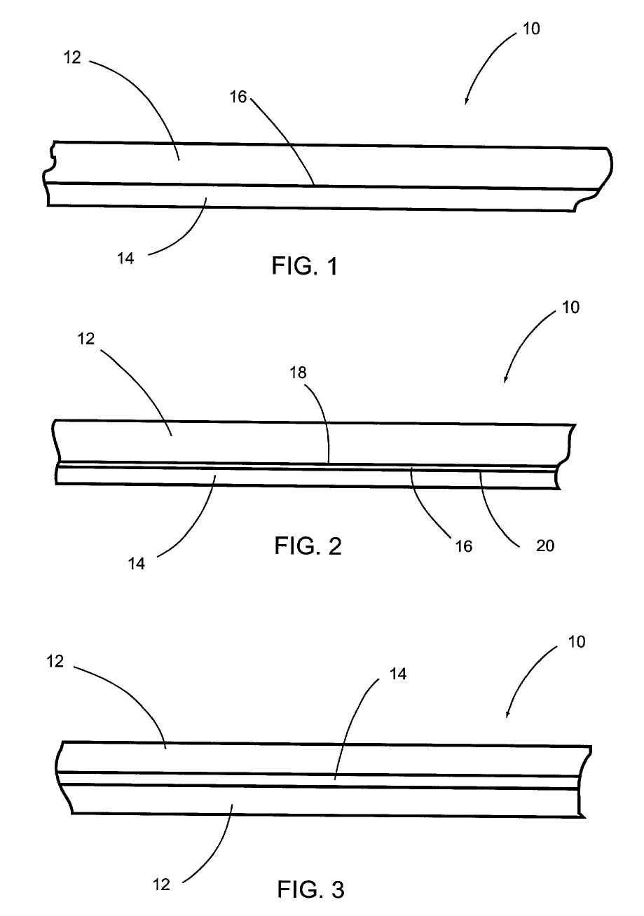

In reference now to the drawings, FIGS. 1 through 3 show schematic cross-sectional diagrams of three implementations of diffuse reflective articles in accordance with the invention. In FIG. 1, a first implementation is shown in which a diffuse reflective article 10 includes a diffuse reflective layer 12 arranged on top of, and bonded to, a dimensionally stabilizing layer 14. Diffuse reflective layer 12 contains a polymeric network having voids (not shown). Diffuse reflective layer 12 and dimensionally stabilizing layer 14 are directly bonded to one another at interface 16 without the use of an adhesive layer. In contrast, in FIG. 2, diffuse reflective article 10 also contains a diffuse reflective layer 12 and a dimensionally stabilizing layer 14, but an adhesive composition 16 bonds the two layers 12, 14 to one another at an upper interface 18 and a lower interface 20. A third implementation, shown in FIG. 3, demonstrates a reflective article 10 with two diffuse reflecting layers 12 placed on both surfaces of a dimensionally stabilizing layer 14.

Typically, the diffuse reflecting layers 12 are thicker than the dimensionally stabilizing layers 14, as shown in FIGS. 1 to 3. It is also possible to make the diffuse reflecting layers 12 thinner than the dimensionally stabilizing layers 14. However, the dimensionally stabilizing layer 14 is normally formed such that it is thinner than the reflective layer 12 so as to maintain a thin overall reflective article that has high reflectivity properties.

The combined thickness of the diffuse reflecting layer (or layers) and the dimensionally stabilizing layers is typically less than 2500 microns thick, more typically less than 500 microns thick, and even more typically less than 250 microns thick. Generally the reflective article is made as thin as possible within the constraints of reflectivity and dimensional stability. Using the dimensionally stabilizing layer of the invention along with a porous diffuse reflector layer allows for improved dimensional stability without excessive loss of reflectivity.

The relative thickness of the diffuse reflective layer to the dimensionally stabilizing layer can vary depending upon the application. However, the diffuse reflector is normally significantly thicker than the dimensionally stabilizing layer. In specific implementations the diffuse reflective layer is greater than five times the thickness of the dimensionally stabilizing layer. In other implementations the diffuse reflective layer is greater than ten times the thickness of the dimensionally stabilizing layer, in yet other implementations the diffuse reflective layer is greater than 40 times the thickness of the diffuse reflective layer.

The combined layers of the invention provide a highly reflective article that is thin and also dimensionally stable. The dimensional stability of the reflective article can be represented by its hand value. The hand value of the dimensionally stabilized films are typically more than 2 times greater than the hand value of the diffuse reflective layer without the dimensionally stabilizing layer, and can be more than 3 times greater than the diffuse reflective layer without the dimensionally stabilizing layer. In certain specific implementations the article has a hand value (measured using a 10 cm by 10 cm sample on a Thwing-Albert Handle-O-Meter) of greater than 300, more typically greater than 400, and even more typically greater than 500 grams.

More detailed description of the materials and methods of the invention, including the specific layers, will now be made:

As used herein, the term “polymer material” refers to polymers that do not substantially absorb light at a wavelength where light is to be reflected and which are melt-processable under melt processing conditions.

As used herein, the term dimensionally stabilizing polymer layer refers to a layer providing improved rigidity to the diffuse reflective article. The dimensionally stabilizing polymer layer improves rigidity while avoiding brittleness. The dimensionally stabilizing layer is typically planer or substantially planer.

As used herein, the term “crystalline” with regard to polymer components includes polymers that are at least partially crystalline, preferably having a crystallinity of greater than 20% as measured by Differential Scanning Calorimetry (DSC). Crystalline polymer structures in melt-processed polymers are known.

As used herein, the term “high density polyethylene” refers to a polyethylene having a crystallinity of 80-90% and a density of 0.94-0.96 g/cm³.

As used herein, the term “melting temperature” refers to the temperature at or above which a polymer material alone or in a blend with a diluent will melt and form a solution.

As used herein, the term “crystallization temperature” refers to the temperature at or below which a polymer material alone, or in a blend with a diluent, will crystallize and phase separate.

As used herein, the term “liquid-liquid phase separation temperature” refers to the temperature above which the polymer and the diluent form a solution, and at or below which a melt of the homogeneous polymer/diluent phase separates by either binodal or spinodal decomposition.

As used herein, the term “diluent-in” refers to a microporous film made by thermally induced phase separation where the diluent component is not removed.

As used herein, the term “diluent-out” refers to a microporous film made by thermally induced phase separation where the diluent component is essentially removed.

As used herein, the term “structure” refers to any unit or article capable of holding or supporting a diffuse reflective material in place, such as, for example, a rigid or flexible frame, an awning, umbrella, backlight constructions having both static or moving images, light conduits, light boxes, LCDs, LED displays, sub-components of LCDs, sub-components of LED displays, and reflectors.

As used herein, the term “optical cavity” refers to an enclosure designed to contain a light source and direct the light from the light source toward an object benefiting from illumination, such as a static display, a changing image or an illuminated object. In certain implementations, the optical cavity includes a lightguide or waveguide.

As used herein, the term “light management film” refers to films designed to control the light, including the direction, polarity, and other properties of light impinging on the light management film. Light management films include, without limitation, turning films, diffuse reflectors, diffusers, and polarizers.

As used herein, the term “surface element” refers to any protrusion, pyramid, depression, recess, ridge, dot, point, extension or other element that extends from the surface or penetrates into the surface of a diffuse reflective article.

As used herein, the term “calender” or “calendering” refers to the process of applying pressure to a material. In certain implementations, calendering is used to reduce the thickness of that material. Concurrent therewith, surface elements can be added to the material. “Calender” or “calendering” preferably refers to application of pressure by pinching a material between the nip of two or more rollers to reduce the thickness of the material.

As used herein, the term “embossing” refers to the process of creating a structured surface on an article by applying pressure and/or heat in combination with a patterned surface to the article.

As used herein, the term “wet out” refers to optical coupling that occurs when two smooth surfaces are separated by less than about 1.5 μm. Optical coupling is particularly serious when one of the surfaces belongs to a waveguide or lightguide that is transmitting light along its length by total internal reflection (TIR). Such coupling serves to provide a path for light to escape from the lightguide in an unwanted manner, causing non-uniform illumination. In a strictly transmissive/reflective mode, the same proximity serves to produce constructive and destructive reflections that make the articles appear to be wet between the surfaces (wet-out) and also appear to have rings at the boundaries, called Newton's Rings.

As used herein, “diluent components” are those components that form a solution with a polymer material at an elevated temperature to form a solution but also permit the polymer material to phase separate when cooled. Useful diluent component materials include (1) those mentioned for solid-liquid phase separation in Shipman, U.S. Pat. No. 4,539,256, incorporated herein by reference, (2) those mentioned as useful for liquid-liquid phase separation in Kinzer, U.S. Pat. No. 4,867,881, incorporated herein by reference, and (3) additional materials such as dodecyl alcohol, hexadecyl alcohol, octadecyl alcohol, dicyclohexylphthalate, triphenyl phosphate, paraffin wax, liquid paraffin, stearyl alcohol, o-dichlorobenzene, trichlorobenzene, dibutyl phthalate, dibutyl sebacate, and dibenzyl ether.

The diffuse reflective layer of the invention contains a desirable density of light scattering sites that combine to create a highly reflective article. The light scattering sites include two regions: a material region and an air region adjacent to each other that have a significant difference between their respective indices of refraction, and that are substantially non-absorbing to the desired wavelength of light that is to be diffusely reflected.

To make an efficient diffuse reflector, the size of the light-scattering regions of the article (i.e. the cross-sectional width or height of fibrils, spherulites, void spaces or other features of the microstructure of the polymeric layer) should be on the order of the wavelength of the light to be reflected. If the size of the scattering sites is a great deal smaller than the wavelength of interest, the light passes through the article. If the size is a great deal larger, the overall thickness required to diffusely reflect most of the light is prohibitively large. Generally, for diffuse light reflectors, the more light-scattering sites per volume the better. Preferably, the material region comprises: (a) at least about 20 parts by weight of a polymer component; and (b) less than about 80 parts by weight of a diluent component.

The unique morphology resulting from diffuse reflectors made via the TIPS process (both solid/liquid and liquid/liquid) is particularly useful in making practical reflectors having high diffuse reflection. The morphology of the solid medium has small dimensions because it is formed by phase separating a polymer and a diluent from a solution. The TIPS articles have solid and air regions (or void spaces) of a particular size and comprise materials that do not absorb radiation in the wavelength desired to be diffusely reflected. Thus, for the diffuse reflection of visible light (380-730 nanometers) suitable polymer materials are, for example, polyolefins such as polypropylene, polyethylene, copolymers of ethylene and vinyl acetate, or compatible mixtures thereof. Also, because the diluent may be present in the finished article in varying amounts, the diluent should also be non-absorbing of light, particularly when more diluent is present or higher diffuse reflectance is desired.

If most of the diluent is extracted, the transparency of the diluent to the light that is being reflected is of little importance. However, the more diluent that remains with the polymer, the more important the transparency of the diluent becomes. In cases where a significant amount of diluent remains, the diluent should be transparent to the radiation being reflected. In this case, one preferred diluent is mineral oil.

In addition to polymer material and diluent, the diffuse reflective layer may also contain conventional fillers or additive materials in limited quantity so as not to interfere with the formation of the article, and so as not to result in unwanted exuding of the additive. Such additives may include anti-static materials, antioxidants, dyes, pigments, plasticizers, ultraviolet light (UV) protectants and absorbers (such as titanium dioxide), or nucleating agents and the like. The amount of additive is typically less than 10% of the weight of the polymeric mixture, preferably less than 2% by weight. Thus, for example, in a solid-liquid TIPS process, the use of a nucleating agent has been found to enhance crystallization of the polymer material, as described in U.S. Pat. No. 4,726,989, which reference is incorporated herein.

The dimensionally stabilizing polymeric layer provides improved rigidity to the diffuse reflective article while preserving a thin profile without excessively diminishing reflectivity or increasing weight of the diffuse reflective article. In particular, the dimensionally stabilizing polymeric layer assists in maintaining the shape of the diffuse reflective article, typically a planer shape when used as a reflector in various lighting applications, such as a reflector in LCD computer displays.

The dimensionally stabilizing layer typically has a glass transition temperature above the normal temperature range that the diffuse reflective article will experience. This range also typically corresponds to a glass transition temperature that is greater than the glass transition temperature of the polymeric components in the diffuse reflective layer. In most implementations the glass transition temperature of the dimensionally stabilizing layer is greater than 40° C., while in specific implementations the glass transition temperature is greater than 70° C.

The polymeric component used in the dimensionally stabilizing layer is selected such that it improves dimensional stability, in particular the hand values of the diffuse reflective article, while preserving the thin profile and reflectivity of the reflective article and avoiding brittleness and the addition of excess weight. Suitable materials comprise various acrylics, including homopolymers and copolymers of commercially available acrylics. Specific additional suitable polymers include polyethylene terephthalate, polycarbonate, poly(methyl methacrylate), and combinations thereof.

The dimensionally stabilizing layer is normally formed to be as thin as possible while providing enhanced dimensional stability. Also, the dimensionally stabilizing layer is advantageously selected and formed such that it does not limit the ability to handle and process the reflective article. Thus, for example, the finished reflective article should be able to be formed into a roll-good for processing and shipping. Typically formation into a roll-good requires wrapping the article around a 3-inch diameter mandrel, and therefore the reflective article of the invention is able to be wrapped around such mandrels in specific implementations of the invention.

The diffuse reflective articles of the invention are typically produced by first forming the diffuse reflective layer(s), and then bonding the dimensionally stable layer to the diffuse reflective layer(s). However, in other implementations the layers can be formed in a different order or can be simultaneously formed. For example, the diffuse reflective layer can be partially formed, bonded to the dimensionally stable layer, and then subsequently finished.

Generally, creation of the diffuse reflective layer(s) requires a polymer and a diluent that can form a single homogenous phase at an elevated temperature. To process a TIPS film, the diluent and polymer are fed into an extruder that heats and mixes the two together to form the homogenous liquid solution. This solution is then either cooled in air or, preferably, cast into a film-like article and cooled upon contact with a casting wheel. During the cooling process for solid/liquid TIPS constructions, the polymer crystallizes out of the solution to cause the formation of a solid polymer phase and liquid diluent phase. The solid phase consists of spherulites held together by polymer chain tie fibrils. In the case of a liquid-liquid TIPS process, the polymer separates out of the solution to form a second liquid phase of polymer-lean material.

After phase separation, the film-like article is typically transparent and can be processed as either a diluent-out or a diluent-in product into microporous film articles. Diluent-out film is made by extracting substantially all of the diluent from the film using a volatile solvent. This solvent is then evaporated away leaving behind air voids where the diluent had been, thus creating a porous film. To increase the air void volume, the film is then oriented or stretched in at least one direction and preferably in both the down-web (also called the longitudinal or the machine) and transverse (also called the cross-web) directions. Diluent-in films are made by simply bypassing the extraction step and orienting the film. After forming the TIPS film, the dimensionally stabilizing polymeric layer is typically attached.

In particular, to achieve the desired light scattering site density with TIPS, the process typically involves:

(1) melt blending to form a solution comprising about 10 to 80 parts by weight of a polymer component that is substantially non-absorbing to the light to be reflected, and about 10 to 90 parts by weight, based on a total solution content, of a diluent component, said diluent component being miscible with the polymer component at a temperature above the melting temperature of the polymer component, or the liquid-liquid phase separation temperature of the total solution;

(2) shaping the solution;

(3) phase separating the shaped solution to form phase separated material, i.e., polymer, regions through either (i) crystallization of the polymer component to form a network of polymer domains, or (ii) liquid-liquid phase separation to form networks of a polymer-lean phase;

(4) creating regions of air adjacent to the material regions to form the porous article; and

(5) adding the dimensionally stabilizing layer.

The size of the material regions (spherulites, cells or other solid structures) in relation to the air or void regions is important to achieve high performance diffuse reflectors. The structure can be varied by manipulation of various process variables, including: (1) quench rate (time for the polymer/diluent solution to cool and phase separate), (2) heterogeneous nucleating agent presence and concentration (useful with solid/liquid TIPS), (3) polymer component to diluent component weight ratio, (4) stretch, (5) diluent extraction, and (6) application of compressing force. The size of the material region of each light scattering site is significantly influenced by the first two and fourth variables. The size of the air region of each light scattering site is influenced by all six variables.

The phase separation step to form the desirable size of material regions to make a useful and economical diffuse reflector can be carried out by (1) cooling the solution fast enough, (2) using nucleating agents (with solid/liquid TIPS), or (3) a combination of both. In TIPS, cooling can be achieved by maximizing the intimate contact of the hot solution to a quenching surface or medium. Microporous films made by the solid/liquid TIPS process may be cooled by casting onto a patterned roll. The film is preferably forced into the patterned roll, such as by a nip-roll, to form structures on the surface that reduce or eliminate wet-out. Alternatively, smooth metal rolls are used to quench the surface or medium. Such smooth metal rolls can result in faster quenching resulting from the solution having better contact with the metal cooling roll results in a nearly dense skin layer on the casting roll side of the film.

The air regions are formed by an interaction of all six process variables mentioned above. For example, in certain implementations, if diluent extraction is used, less stretching and a higher content of diluent should be used to achieve a desired diffuse reflector. Likewise, if diluent extraction is not used, more stretching is desirable and if both diluent extraction and stretching are used, lower diluent content is generally desirable. A fast quench rate or the presence of nucleating agent and the concentrations of nucleating agent used influence the number of spherulites (solid/liquid) or polymer lean cells (liquid/liquid) that are formed which in turn influences the distribution of the air that fills the voids caused by stretching or washing.

The dimensionally stabilizing polymeric layer is typically added after the regions of air adjacent to the material regions have been formed to create the diffuse reflective layer. In specific implementations, the dimensionally stabilizing polymeric layer is formed by coating a polymeric material onto a surface of the diffuse reflective layer. The polymeric material can be a thermoplastic material that is applied at an elevated temperature and then cools. Alternatively, the polymeric material may be a solution or suspension that is dried to form the stabilizing polymeric layer. Alternatively, the polymeric material may be applied as a monomer and then polymerized into a solid material. In each implementation the material forming the stabilizing polymeric layer can be applied by known coating methods, including roll coating, knife coating, extrusion coating, and spraying. In alternative implementations the dimensionally stabilizing polymeric layer is formed independently of the diffuse reflective layer and then the two layers are bonded to one another, such as by use of an adhesive composition or by heating the two layers to an elevated temperature.

In specific implementations, the diffuse reflective article of the invention is also compressed in order to improve dimensional stability, particularly shrinkage and wrinkles that can form as a consequence of such shrinkage. The portion of the article that benefits from compression is typically only the diffuse reflective layer, and thus the article can be compressed before or after the dimensionally stabilizing layer or layers have been applied. Compression is desirable because it can create a thinner reflector having improved dimensional stability, excessive compression can result in unacceptable degradation of the reflective properties of the voids. Such degradation is believed to occur either through collapse of the voids or shrinkage of the voids beyond their functional reflective thickness because they have become too close in thickness to the wavelength of the light present. Preferably, the amount of compression is such that the compressed article has a thickness of between 60% and 95% of its original thickness, more preferably between 70% and 85% of its original thickness, and most preferably between 75% and 80% of its original thickness. The compressed article preferably has a thickness of between 50 and 500 μm, more preferably a thickness of between 100 and 400 μm, and most preferably between 150 and 300 μm.

The reflectivity of the compressed article may vary from that of the non-compressed article. However, when the compression results in decreases in reflectivity, that decrease is preferably less than 5 percent of the reflectivity of the non-compressed article, more preferably less than 3 percent of the reflectivity of the non-compressed article, and even more preferably less than 1 percent of the reflectivity of the non-compressed article.

The compressed article has improved stability relative to the uncompressed article in certain implementations. This stability is apparent, for example, in that the compressed article experiences less shrinkage when exposed to heat. In particular, the compressed article shows less deformation and shrinkage along its length and width than uncompressed articles. This reduction in shrinkage reduces wrinkling and rippling of the article when it is placed within a frame, such as the bevel surrounding an LCD or LED display. In certain implementations, the dimensional stability is such that the article shows from 5 to 50 percent less initial shrinkage than uncompressed articles under the same conditions of heat exposure; while in other implementations the article shows from 5 to 25 percent less initial shrinkage than uncompressed articles.

Furthermore, various surface elements can be added to the diffuse reflective article of the invention in order to reduce the wet-out in that area, such as proximate the light source. Appropriate surface elements should have a very low wet-out characteristic, such as a point of a cone or pyramid. Such low wet-out elements are advantageous because they lift the reflecting surface away from the structure, thereby preventing wet-out from forming. Separation between the diffuse reflective article and structure should typically be greater than about 1.5 μm.

The diffuse reflective articles of the present invention have a wide variety of light management applications. In a multi-layer system, the light diffusing layer may be combined in a number of reflective devices with a specular reflective layer. The light diffusing article may be used to partially line an optical cavity to increase the efficient use of light to illuminate such things as, for example, a partially transparent image that may be either static (such as a graphics film or a transparency) or switchable (such as a liquid crystal display).

Thus, optical cavities that are partially lined with diffuse reflector films of the invention may be used in such devices as backlight units including as liquid crystal display constructions (LCDs), lights, copying machines, projection system displays, facsimile apparatus, electronic blackboards, diffuse light standards, and photographic lights. They may also be part of a sign cabinet system, a light conduit or units containing light emitting diodes (LEDs).

When used in these various light management applications, the diffuse reflective article can be combined with other light management films to provide improved optical properties for displays, including liquid crystal displays incorporated into computer monitors, handheld computers, mobile communication devices, etc. The light management films used in association with the diffuse reflective article includes polarizing films, turning films, and brightness enhancing films. Suitable polarizing films include reflective polarizers, cholesteric polarizers, Brewster polarizers, and wire-type polarizers.

Suitable polarizing films include reflective polarizers, cholesteric polarizers, Brewster polarizers, and wire-type polarizers. Turning films suitable for use with the invention typically adjust the angle of light exiting a light guide in order to direct the light toward a viewer. Such turning films include prismatic films with the apex of the prisms facing towards the lightguide and running perpendicular direction of light travel in the lightguide. These turning films can have included angles ranging from 40° to 80°. Preferably in the range from 62° to 78°. The surface opposite the turning film prisms can be smooth or can have some structure. The structure could be used for diffusion or angle management of light coming through the turning film. Any of the same structures used in structured surface light management films could be used on such opposing surface. Brightness enhancing films include films that receive light traveling in an input wedge and emit light in an output wedge where the output wedge is a narrower range of angles than the input wedge, such as a prismatic reflecting film.

The diffuse reflective article of the present invention has been found to be especially beneficial as a back reflector in commercial back lights used for liquid crystal displays. In this type of application, the article is placed directly behind the light source that is illuminating a display. The porous film acts to reflect back light that is not directed toward the display and ultimately a viewer. The scattering or diffuse reflection characteristics of the porous film back reflector also helps provide a more overall diffuse light source and more evenly lit display, and are suitable as diffuse reflector and polarization randomizers as described in Patent Application Publication No. WO 95/17699 and U.S. patent application Ser. No. 08/807262 filed Feb. 28, 1997. Incorporated herein by reference in their entirety.

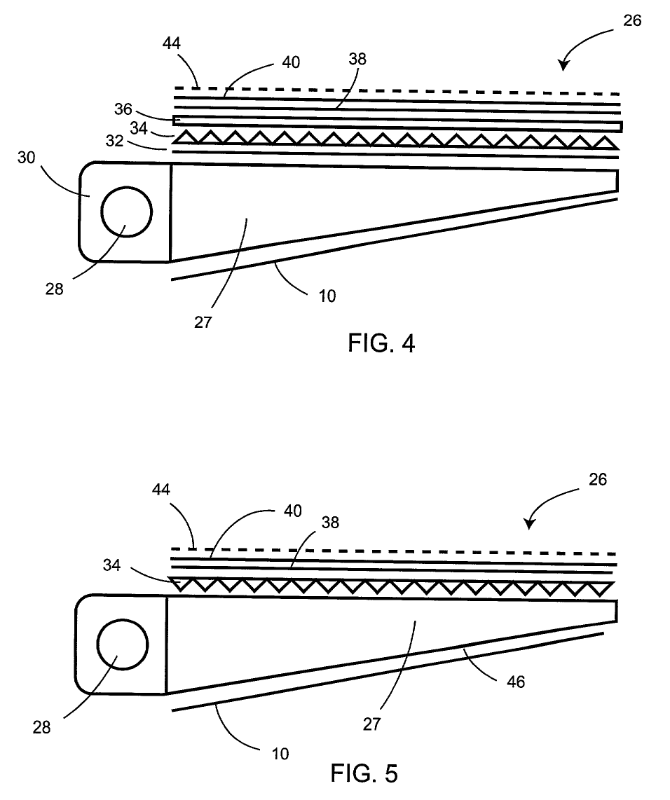

Schematic figures of several constructions using liquid crystal displays (LCD) and incorporating these diffuse reflecting articles are shown in FIGS. 4 and 5. In FIG. 4, an LCD device 26 is shown with light guide 27 and light source 28 in cavity 30. Light guide reflector film 10 reflects light extract from the back of light guide 27 back toward the LCD panel 44. Prismatic recycling films 34, 36 (shown oriented at 90 degrees to one another) recycle stray light back into the light guide 27. Reflective polarizer 38 also reflects light that is not properly polarized for the LCD. A cover film 40 is also shown.

In FIG. 5, an LCD device 26 is shown, containing a light guide 27 and a light source 28. The light guide can be a tapered to have top and bottom surface that are angled toward one another to form a wedge, or may be a flat waveguide having top and bottom surfaces that are parallel or may have step structures on one or both surfaces. A light direction turning film 34, a diffuser 38, a reflecting polarizer 40, and the LCD panel 44 are also shown. Light guide reflector film 10 covers the bottom surface 46 of the light guide 27. Additional films may be placed between these films.

LEDs are useful light sources for small LCD devices such as medical monitors and automotive displays. LEDs provide the advantages of small size and lower energy consumption, but they have relatively low luminance. The optical efficiency of designs using LED illumination is increased when a diffuse reflective article of the present invention is used as a back reflector in combination with brightness enhancing and reflective polarizer films.

LEDs can replace fluorescent lamps as the preferred backlight source for small liquid crystal displays such as medical monitors and automotive displays. The advantage of using LEDs is their low price, small size and low energy consumption. The disadvantage of LEDs is their relatively low brightness. With the use of the diffuse reflective article of the present invention as a back reflector along with known specular reflective film layers, the brightness of LED displays can be increased.

The diffuse reflective article of the invention is also useful in light conduits or applications wherein light is extracted from or emanates from at least a portion of the length of the hollow light conduit. The source of light for a light conduit is typically a point source such as a metal halide lamp, or in the case of rectangular display conduit a linear light source such as a fluorescent tube may be used. Typical applications are general lighting or display lighting that includes such displays as colored tubes and thin display images and signs. Commercially available light conduits (available from 3M and/or described in U.S. Pat. Nos. 4,805,984, 4,850,665 and 5,309,544) currently use diffuse reflectors such as a matte white vinyl film to extract the light and direct it through an emitting surface, and a silver coated poly(ethylene terephthalate) film or TYVEK™ film to back reflect stray light.

As discussed above, the diffuse reflector of the present invention may be used in conjunction with other light management films. These light management films may include turning films, brightness enhancing films, diffusers, reflective polarizers, etc. In specific implementations, light-recycling enhancement films are used to provide significant improvements in display brightness by reflecting a selected portion of the light through the light guide to the diffuse reflector in order to enhance selected properties of the light such as direction or polarization. Such recycling films fall into the category of gain-providing films such as prismatic recycling films, diffusers, and reflecting polarizers to increase the brightness of the display. The increased reflectivity of the diffuse reflector of the invention becomes even more beneficial when the light reflects off of it multiple times.

The gain-providing films reflect light that has already been extracted back to the diffuse reflector and therefore increase the diffusivity beyond what the diffuse reflecting film can accomplish with single reflections. By increasing the diffusivity, it is possible to reduce the number of additional diffusers that are necessary in the system, or reduce the necessary diffusiveness of films added to mask the extraction patterns or provide the diffusion needed for the recycling films to work.

This invention also relates to a display system in which the diffuse reflector doubles as a medium on which ink, paint, or other materials may be printed or applied to locally influence the degree of reflection of the film. It relates to a display illumination system in which the diffuse reflector works in conjunction with structured films and/or reflecting polarizers to provide sufficiently diffuse light that the optical effects of the extraction structures of the light-guide are not noticeable. A wide variety of different embodiments may reproduce the effects described here.:

The gain-providing film may be any type of structured layer, patterned layer, or composite layer that acts to reflect some light to the diffuse reflecting surface. This may include prismatic or other brightness enhancing films, as defined above, surface or bulk diffusing films, and other films which act to provide gain through reflecting light incident at certain angles and transmitting light incident at other angles. It may also include films patterned such that light incident on certain areas of the display (such as the areas where the TFTs are located) is reflected toward the diffuse reflector. It may include layers which, through some surface coating or bulk property, reflect some incident light back toward the diffuse reflector It may also be a layer which consist of several different materials combined to form a reflecting structure that returns some light to the diffuse reflector.

Use of gain-providing layers can be particularly well suited to LCD touchpanel applications, where significant loss in light often occurs. For this reason the increased reflectivity of the diffuse reflector of the invention is particularly well suited for use in touchpanel applications. The diffuse reflector and some of its uses are further described in the following examples.

### EXAMPLES

The invention is further illustrated by the following examples, which are not intended to limit the scope of the invention. The total reflectance spectra was determined by using the procedures described in ASTM E 1164-94. A sample was placed in a Lambda 900 Spectrometer available from Perkin Elmer outfitted with an integrating sphere. The output was a percent reflectance for each wavelength over a predetermined range of wavelengths of either from 380 nanometers (nm) to 730 nm or from 250 nm to 2000 nm.

### Example 1

In Example 1, approximately 225 microns thick samples of TIPS film were coated with an acrylic clearcoat to determine any change in dimensional stability and any change in reflectivity of the TIPS film before and after being coated.

The TIPS film was formed from a transparent polymer component (crystallizable polypropylene available under the trade designation of DS 5D45 from Union Carbide with a melt flow index of 0.65 dg/min (ASTM D1238, Condition I), crystallinity of 48%, a melting point of 165° C. (measured by DSC) and an index of refraction of 1.50) mixed with a nucleating agent (dibenzylidine sorbitol, available as MILLAD™ 3905 from Milliken Chemical, Inman S.C.) and fed into the hopper of a 40 mm twin-screw extruder. A transparent oil component (Mineral Oil Superla White #31 available from Chevron), having a viscosity of 100 centistokes (ASTM D445 at 40° C.) and an index of refraction of 1.48, was introduced into the extruder through an injection port at a rate to provide a composition of 55% by weight of the polymer, 45% by weight mineral oil and 2000 parts by weight of nucleating agent per million parts of combined polymer and diluent. The polymer was heated to 271° C. in the extruder to melt and, after mixing with the oil, the temperature was maintained at 177° C. during the extrusion. The melt was extruded through a slit die and cast as a transparent film onto a casting wheel maintained at 66° C. and having a smooth surface. The cast film was washed in 1,1-dichloro 2,2,2-trifluoroethane (available as VERTREL™ 423 from DuPont) for 15 minutes in a counterflow extractor, dried for 9 minutes at 47° C. and stretched 2 by 2 times (in both the machine and transverse directions) at 115° C. The initially transparent film turned opaque white upon extraction and had a final thickness of about 230 microns.

An acrylic clear coat was applied to a first sample of the TIPS film by hand spreading a 75 micron thick solution of poly(methyl methacrylate) containing 20 percent solids in organic solvents onto the TIPS film using a knife coating bar, followed by drying the solvents under evaporative conditions. A second sample was formed by hand spreading a 125 micron thick layer of the acrylic clear coat solution onto the 230 micron thick TIPS film. The films were allowed to dry and then were tested for total thickness, for reflectivity with the light source incident on the TIPS film side of the film, and for stiffness as represented by measured hand value. The hand values reported for the following examples were obtained on a Thwing-Albert Handle-O-Meter Model No. 211-300 (Thwing-Albert Instrument Co., Philadelphia, Pa.), according to the procedures outlined in the instruction manual included with Model No. 211-300. All of the hand measurements were performed on approximately 4 centimeter square sheet materials. The results are shown below in Table 1:

TABLE 1

| | | Thickness¹ | % Reflectivity | Hand (g) |
|---|---|---|---|---|
| Uncoated TIPS | | 236 | 97.9 | 170 |
| 75 | micron acrylic solution | 244 | 98.0 | 543 |
| | coating² | | | |
| 125 | micron acrylic solution | 259 | 98.2 | 719 |
| | coating² | | | |

¹Dry thickness in microns, after acrylic has been cured.
²Coating thickness of acrylic solution before solvent evaporation.

As indicated in Table 1, the acrylic clear coat added a very modest thickness to the uncoated TIPS film of 8 and 23 microns, respectively, for the 75 micron thick and 125 micron thick acrylic solution. In addition, there was no apparent diminishment in percent reflectivity, and in fact some increases in reflectivity were observed. However, the hand measurements showed dramatic increases of over 200 and 300 percent, respectively, for the two examples coated with acrylic layers.

### Example 2

In Example 2, a sample of thinner TIPS film was laminated to a dimensionally stabilizing layer to determine the improvement in dimensional stability and any change in reflectivity of the TIPS film before and after being laminated.

Approximately 175 and 225 microns thick samples of TIPS diffuse reflective film made in accordance with the procedures of Example 1 were provided. An approximately 50 micron thick white polyester tape was laminated to the 175 micron thick diffuse reflective film. The tape, sold as ScotchBrand 850 White by 3M Company of St. Paul, Minn. includes a 20 micron thick PET backing and a 30 micron thick white-pigmented adhesive. Each of three reflectors was measured for thickness, percent reflectivity, and Hand. The results are summarized in Table 2, below.

TABLE 2

| | Thickness (μm) | % Reflectivity | Hand (g) |
|---|---|---|---|
| Unlaminated TIPS | 225 | 97.9 | 170 |
| Unlaminated TIPS | 175 | 97.2 | 99 |
| TIPS (175 microns) plus | 225 | 97.9 | 476 |
| polyester tape (50 microns) | | | |

As indicated in Table 2, the thickness and reflectivity of the laminated sample is the same as the 225 micron thick unlaminated TIPS film. However, the hand value of the 225 micron thick sample containing the polyester tape backing was nearly three times that of an unlaminated TIPS film of the same thickness.

### Example 3

In Example 3, samples of TIPS film approximately 175 microns thick were laminated to polypropylene and polyethylene terephthalate (PET) to determine any change in dimensional stability and any change in reflectivity of the TIPS film, as well as to determine whether a TIPS film laminated to these materials would demonstrate reduced curling under elevated temperatures.

Samples of approximately 175 micron thick TIPS film were laminated to polypropylene and PET laminates. In a first sample, a 175 micron thick sample of TIPS film made in accordance with Example 1 was laminated to an 86 micron thick, white polypropylene-backed label stock material (#7776 available from 3M Company) which consists of a 66-micron thick biaxially oriented polypropylene film with a 20 micron thick acrylic adhesive. In a second sample, a 175 micron thick sample of TIPS film made in accordance with Example 1 was laminated to an 89 micron thick white, polypropylene-backed label stock material (#7776 available from 3M Company) which consists of a 66-micron biaxially oriented polypropylene flim with a 23 micron thick acrylic adhesive. In a third sample, a 175 micron thick sample of TIPS film made in accordance with Example 1 was laminated to a 70 micron thick, white PET-backed labelstock material (#7816 available from 3M Company) which consists of a 50-micron thick PET film with a 20 micron thick layer acrylic adhesive. These three films were tested for reflectivity, stiffness, and maximum curl height of a 10 by 10 cm sample after 1 hour at 85° C.

TABLE 3

| Backing | Thickness | % Reflectivity | Hand (g) | Max Curl (mm) |
|---|---|---|---|---|
| Polypropylene | 264 | 97.2 | 545 | 2 |
| Polypropylene | 267 | 97.6 | 509 | 8 |
| PET | 245 | 97.7 | 519 | 28 |

As indicated in Table 3, the Hand values for all three samples were relatively high compared to TIPS films that do not contain a dimensionally stabilizing layers (see Examples 1 and 2). In addition, the samples containing a polypropylene laminate showed very low levels of curling, believed to be a result of the fact that the TIPS film and the laminate both contained polypropylene, and thus both contained similar ingredients having similar expansion properties.

The above specification and examples are believed to provide a complete description of the manufacture and use of particular embodiments of the invention. Many embodiments of the invention can be made without departing from the spirit and scope of the invention.

What is claimed is:

1. A diffuse reflective article comprising:
a diffuse reflective layer containing a polymeric network having voids therein, the network including a polymeric component and a diluent component, said diluent component being miscible with the polymeric component at a temperature above the melting point of the polymeric component; and
a dimensionally stabilizing polymeric layer.

2. The diffuse reflective article of claim 1, wherein the diffuse reflective layer contains a polymer selected from the group consisting of polypropylene, polyethylene, and combinations thereof.

3. The diffuse reflective article of claim 1, wherein the diffuse reflective layer comprises:
(a) at least about 20 parts by weight of the polymer component; and
(b) less than about 80 parts by weight of the diluent component.

4. The diffuse reflective article of claim 1, wherein the dimensionally stabilizing polymeric layer has a glass transition temperature greater than 40° C.

5. The diffuse reflective article of claim 1, wherein the dimensionally stabilizing polymeric layer has a glass transition temperature greater than 70° C.

6. The diffuse reflective article of claim 1, wherein the dimensionally stabilizing polymeric layer comprises an acrylic coating.

7. The diffuse reflective article of claim 1, wherein the dimensionally stabilizing polymeric layer contains particles.

8. The diffuse reflective article of claim 7, wherein the particles are white pigments.

9. The diffuse reflective article of claim 1, wherein the dimensionally stabilizing polymeric layer contains absorbing dyes or pigments.

10. The diffuse reflective article of claim 1, wherein the dimensionally stabilizing layer comprises at least one polymer selected from the group consisting of polyethylene terephthalate, polycarbonate, polymethylmethacrylate, and combinations thereof.

11. The diffuse reflective article of claim 1, wherein the dimensionally stabilizing polymeric layer contains voids.

12. The diffuse reflective article of claim 1, wherein the combined thickness of the diffuse reflective layer and the dimensionally stabilizing polymeric layer is less than 350 microns.

13. The diffuse reflective article of claim 1, wherein the diffuse reflective layer is from 2 to 40 times as thick as the dimensionally stabilizing polymeric layer.

14. The diffuse reflective article of claim 1, wherein the diffuse reflective layer is from about 2 to about 5 times as thick as the dimensionally stabilizing polymeric layer

15. The diffuse reflective article of claim 1, wherein the dimensionally stabilizing polymeric layer is laminated to the diffuse reflective layer with an adhesive. The diffuse reflective article of claim 13, wherein the adhesive contains a white pigment.

16. The diffuse reflective article of claim 1, further comprising surface elements configured to reduce optical coupling.

17. The diffuse reflective article of claim 1, wherein the diffuse reflective article has a reflectivity greater than 92% at a wavelength of 550 nm according to ASTM E 1164-94 using a spectrophotometer with an integrating sphere.

18. A diffuse reflective article comprising:
a diffuse reflective material proximate to a structure wherein said diffuse reflective material is made of a porous polyolefin sheet comprising a network of polymer domains and fibrils interconnecting the domains, and
a dimensionally stabilizing polymeric layer.

19. The diffuse reflective article of claim 18, wherein the porous polymeric sheet has a reflectivity greater than 92% at a wavelength of 550 nm according to ASTM E 1164-94 using a spectrophotometer with an integrating sphere.

20. The diffuse reflective article of claim 18, wherein the diffuse reflective material comprises:
(a) at least 20 parts by weight of a polymer component; and
(b) less than about 80 parts by weight of a diluent component.

21. The diffuse reflective article of claim 20, wherein the polymer component is substantially non-absorbing to light at a wavelength between 380 and 730 nanometers.

22. The diffuse reflective article of claim 20, wherein the polymer component is selected from the group consisting of polypropylene and polyethylene.

23. The diffuse reflective article of claim 20, wherein the diluent component is mineral oil.

24. A display containing the diffuse reflective article of claim 1.

25. The diffuse reflective article of claim 1, used in association with light management films selected from reflective polarizing films, turning films, brightness enhancing films, diffusers, and films including hemispheres, cylindrical structures or lenslets.

26. A method of making a diffuse reflecting article configured for positioning proximate to a structure, the method comprising:
providing a polymer component;
providing a diluent component, said diluent component being miscible with the polymer component at a temperature above the melting point of the polymer component;
combining the polymer component and diluent component to form a porous polymeric sheet; and
securing a dimensionally stabilizing polymeric layer to the polymeric sheet.
